(19) United States
(12) Patent Application Publication
(10) Pub. No.: US 2013/0008978 A1
(43) Pub. Date: Jan. 10, 2013

(54) Advanced Method and Apparatus for Spraying and Containing Atomized Materials

(76) Inventor: William C. Smith, Los Angeles, CA (US)

(21) Appl. No.: 13/176,065

(22) Filed: Jul. 5, 2011

(51) Int. Cl. B05B 9/03

(52) U.S. Cl. 239/302

(57) ABSTRACT

The invention is directed to an apparatus and method for spraying atomized materials from a handheld device. The device may spray highly toxic chemicals. During spraying certain components of the device come into contact with the material which is atomized. These components will be disposed of as opposed to cleaned. The new assembly includes means to attach to a coating container, with a atomizing tube atop connecting means. A tube would be included that would be disposed inside the container and attached to the downside of the atomizing tube. The atomizing tube-attachable cover and tube include no moving parts and are easily affixed to the container and the atomizing gas supply. Further, the instant system can be mated with airborne contaminant recovery systems.

### CROSS REFERENCE TO RELATED PATENTS

U.S. Pat. No. 5,271,564 with an issue date of Dec. 21, 1993, U.S. Pat. No. 6,029,909 with an issue date of Feb. 29, 2000 and U.S. Pat. No. 7,550,022 with an issue date of Jun. 23, 2009; all issued to William C. Smith, are herein incorporated in their entirety by reference.

### BACKGROUND OF THE INVENTION

1. Field of the Invention

The invention relates to advances in spraying devices which include disposable parts, incorporated into low pressure spray devices. The invention may be incorporated into other spray devices which may employ other means to spray than the fluid to a target.

2. Description of the Related Prior Art

U.S. Pat. No. 5,271,564 issued to Smith and incorporated by reference is directed to spray tool extensions. An extension permits the application of material, in atomized and in other states, above, below, around, behind or into a device which is to be coated or have fluent material placed upon. A variety of nozzles may be used, these nozzles including a fixed nozzle, a variable pattern nozzle and a fan shaped nozzle. The extension is claimed to be rotatively mounted onto a spray tool, and further has a spray assembly, which includes the nozzle, mounted on its other end.

U.S. Pat. No. 6,029,909 issued to Smith and incorporated by reference is directed to a dual induction apparatus for high volume low pressure spraying. This discloses a venturi tube with a plurality of ports incorporated into the spray system. Compressed air is projected on one side of the venturi which forms a low pressure area, entraining the material to be sprayed up a tube. At this point it is atomized, with the compressed air in addition to air brought in through ports located in the venturi. The atomized material is then discharged through an exit, where it is delivered to a target.

U.S. Pat. No. 7,550,022 issued to Smith and incorporated by reference is directed to a portable system to capture airborne pollutants. The device includes a flexible and maneuverable source connection means that can be connected to an atomizer, including a spray tool or aerosol can. Further means to create a suction or a lower pressure or the like allows contaminated air and air from the environment to flow from the source containment means to a filter, where the pollutants are removed. After filtration, the treated air is removed from the proximity of the user.

All of the above patents may be modified by the instant invention wherein the components which come into contact with the fluid to be sprayed will be directly replaced after use.

### SUMMARY OF THE INVENTION

Cleaning of atomizing tools is a major problem in the art of spraying. After a spray device is used, its efficiency is impaired and it must be cleaned. These devices are used to spray highly contaminating solvents which have materials which, when the solvent vaporizes, leaves a toxic residue. Currently these atomizing devices are taken to cleaning rooms and cleaned by trained people who are provided with personal safety equipment. Specialized tools are employed during the cleaning of the contaminated parts, such as brushes, picks and the like. These, after use, are categorized as hazardous material and must be treated, handled, and disposed of as such. This is to protect the health of the worker. Unclean atomizing components reduce transfer efficiency and generally do an inferior job of spraying a surface; therefore it makes good sense to have clean components. For all the positive sides of spraying, this is the real “down side”. The people who clean such devices draw a salary, require training, and incur costs for the personal safety equipment. Additionally, the cost of coating materials has increased substantially, so that any impairment of transfer efficiency or any loss such as to overspray is definitely unwelcome.

The current invention provides a spraying system and apparatus where all components of the system downstream of an atomizing gas or compressed air source, the components which are currently cleaned, will now be replaced after each use. This would include the atomizing tube, the suction hose and means to attach the suction hose through the distal end of the atomizing tube. The atomizing tube would include means to secure it to the top of a coating container. This coating container would have ifs cover removed, and the atomizing tube with attachment means and hose would be affixed atop the container. After spraying, the atomizing tube with attachment means would be decoupled from the compressed air source and then decoupled from the container. If there is material left in the reservoir it may be resealed. Prior to resealing, any material which may be easily flowing (such as that in the tube) may be discharged back into the standard coating container. Then, the atomizing tube with attachment means with hose attachment would be properly disposed of. The atomizing gas or compressed air source is not contaminated, therefore, a new coating container may be opened, affixed to a new atomizing tube with attachment means and hose, and spraying with a new, unused atomizing tube with connection means and hose may begin. This new modular structure and improved method of use obviates the need for cleaning and saves material dispensed and money.

Transfer efficiency is the portion of the atomized material that is actually deposited on the work piece. For instance if the transfer efficiency of a specific spray tool is 75%, it means that 75% of the material is applied to the work. The remainder is commonly referred to as overspray or waste.

The definition of spraying module is the combination of the atomizing tube with container attachment means and suction hose.

The definition of use is when there is a requirement to either stop spraying, change the substance being sprayed, or change the empty spraying container. Further, the user may determine when the spray efficiency is being impaired and the spraying module be changed. Since there are no moving parts this may be easily and quickly accomplished. In this fashion, there will be no fouling of the suction hose or the atomizing tube. This is due to the fact that once fouling or transfer efficiency impairment is detected the spraying module may be changed to one that has not been used; hence, unfouled hose and tube, with the maximum transfer efficiency.

Devices which attach downstream of the atomizing tube to prevent overspray, errant spray, containment and the like, generally are of the type which do not require replacement. However, they may be changed out, especially when the spraying material changes. This would prevent any chance of contamination of the new substance being sprayed.

The new invention could be considered as a spray tool module which is disposable. This module would be attached to the top of a standard coating container, has simple means to plug into a compressed air source on a first input side, and simple means to attach any spray modifying device on the output side. Again, substantial time and money can be saved by not reusing the fouled components which form the spray tool module. The spray tool module has no moving parts.

Containers of atomizable material come in a variety of forms. They may be metal or plastic containers with lids, bladders of material, drums (such as the 55 gallon variety), tanks, and most likely a variety of other types. Any and all of these containers may be employed with the instant spray module. All that needs to happen is have the suction hose be placed in the material by whatever process, be it attaching the module to the container or passing the suction hose through the bladder.

The list of materials which could be sprayed by the instant invention is too large to include in this discussion. The following may be employed, but should not be considered limiting in any fashion. Paints, pesticides, fungicides, plastic coatings, powders, solvents, lubricants, radar absorbing material, adhesives, anti-corrosion agents or even water. This may be ideal for medical applications, for the spraying of medicines, both topically or inside the body. Further, the instant invention may be ideal for zero gravity applications. It is believed any liquid and most fine powders may be utilized. Viscosity has a huge role in whether a material may be atomized. For the purposes of this invention, let it just be said that any material designed to be sprayed currently or developed the future would be an excellent candidate to be employed with the instant system.

### BRIEF DESCRIPTION OF THE DRAWING FIGURES

The accompanying drawing figures, illustrate several uses of the instant invention as well as different embodiments. These figures will help to explain the principles of the invention. These drawing figures should not be considered to be limiting on the scope of the invention.

FIG. 1 discloses the spray module in relation to one of many possible atomizing gas sources and includes a post atomization tube spray modifying system including a movable wand and a representative nozzle.

FIG. 2 discloses the spray module in relation to one of many possible atomizing gas sources and includes a second embodiment including a type of post atomization containment means.

FIG. 3 discloses the spray module in relation to one of many possible atomizing gas sources and includes a third embodiment including an elongated suction hose being deployed into a container in such a fashion where the container attachment means is remote from a generic container.

FIG. 4 discloses the spray module in relation to one of many possible atomizing gas sources and includes a fourth embodiment of the spray module being employed wherein the suction hose is placed in a container in such a fashion where the container attachment means is in a position just prior to being affixed to the container; two of many possible downstream devices are shown which may be affixed to the exit side of the atomization tube.

FIG. 5a discloses a top view of the atomizer module.

FIG. 5b discloses a side view of the atomizer module, with the suction hose interface shown in para exploded view. A Para-explosive view shows one possible means to attach the suction hose through and to the atomizing tube without the side structure of the container attachment means of the atomizer module from occulting the view.

### DETAILED DESCRIPTION OF THE PREFERRED EMBODIMENTS

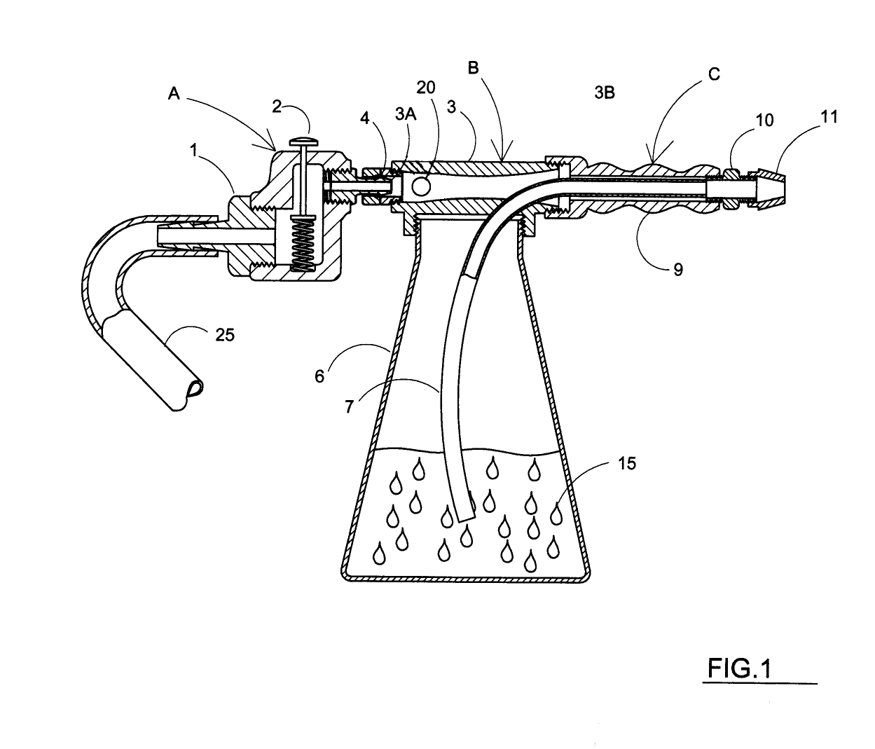

Referring to the drawings wherein the showings are for purposes of illustrating the preferred embodiments of the present invention only, and not for purposes of limiting the same. The instant figures, FIGS. 1 through 5b inclusive, illustrate an spray tool employing the atomizer module of the invention.

FIG. 1 discloses the modularization of the invention, including a first sub module A shown just prior to being affixed to the main atomizer module B of the invention. Additionally, module C is shown affixed to the main atomizer module B.

Module A is considered to be a connector and regulator of an atomizing gas source. Element 1 is a male connecting mechanism for attachment to a hose (not shown). The hose (not shown) delivers an atomizing gas through element 1. Element 2 is a atomizing gas valve which is manually actuatable. The atomizing gas valve 2 is not limited to the configuration shown in FIG. 1. Module A may include, but is not limited to, any gas regulation device. Compounds employed as atomizing gases include, but are not limited to, compressed air, compressed carbon dioxide, and compressed propane. In module A an element 4 is provided. It restricts the atomizing gases passing thought module A and includes means to attach to a first or input side 3A of the main atomizer module B. It is anticipated that the attachment means provided to attach module A to module B would be of such style known as quick attach and subsequent quick release. The attachment means or system may be chosen to be any which would permit the atomizing gas source module A to be connected to the inlet side of the main atomizer module B.

Module B is comprised of an atomization tube 3 through which the suction hose 7 passes through. The atomization tube 3 is centrally affixed atop a circularly shaped container cover 5. In FIG. 1 the suction hose 7 passes from the material 15 to be atomized to the end of a flexible hose 9 which terminates at nozzle 10. Immediately adjacent nozzle 10 is an aircap 11 for shaping the exiting air for shaping or containment. The air which passes through the nozzle 10 has the material 15 atomized therein and is being carried or forced by the atomizing gas toward a target which is desired to be coated.

To recap, FIG. 1 shows three modules showing how they are interconnected. Module A is the compressed atomizing gas supply which in this case is manually actuated. One may envision a future scenario where spraying is automated and the human worker is replaced by something akin to a robotic assembly line, or further still, with advances in said robotic technology, individual computer controlled robots with smart systems (artificial intelligence) may employ the instant invention receiving the same benefits of both saving time and saving coating material. For the moment; however, a human worker will attach module A to module B.

Module B comprises the atomizing tube 3 centrally affixed atop container connection means 5. Suction hose 7 extends from the coating material 15 through the container connection means 5 and finally into the atomizing tube 3. In this embodiment, due to the specific choice of the C-module, the drain hose 7 traverses coaxially through the exit side of the atomizating tube 3, down coaxially the wand 9 where it is connected to the nozzle 10. Other embodiments may warrant differing structural configurations. Atomizing tube 3, in one embodiment of the invention, may include a plurality of air intake ports 20 located proximal the atomizing tube 3 input side 3A. The atomizing tube 3 may be any type of atomizing tube including one having an equal diameter aperture from the input side 3A to the exit side 3B, an atomizing tube of the venturi type or an atomizing tube having any other configuration. The instant invention does not require a specific atomizing tube 3 to have unique structure and method in the instant invention.

The atomizing tube 3 may be affixed to the container connection means by any method. It has been considered to use, but not limited to, adhesives, mechanical fasteners, hook and loop fasteners, integral molding and other connection means.

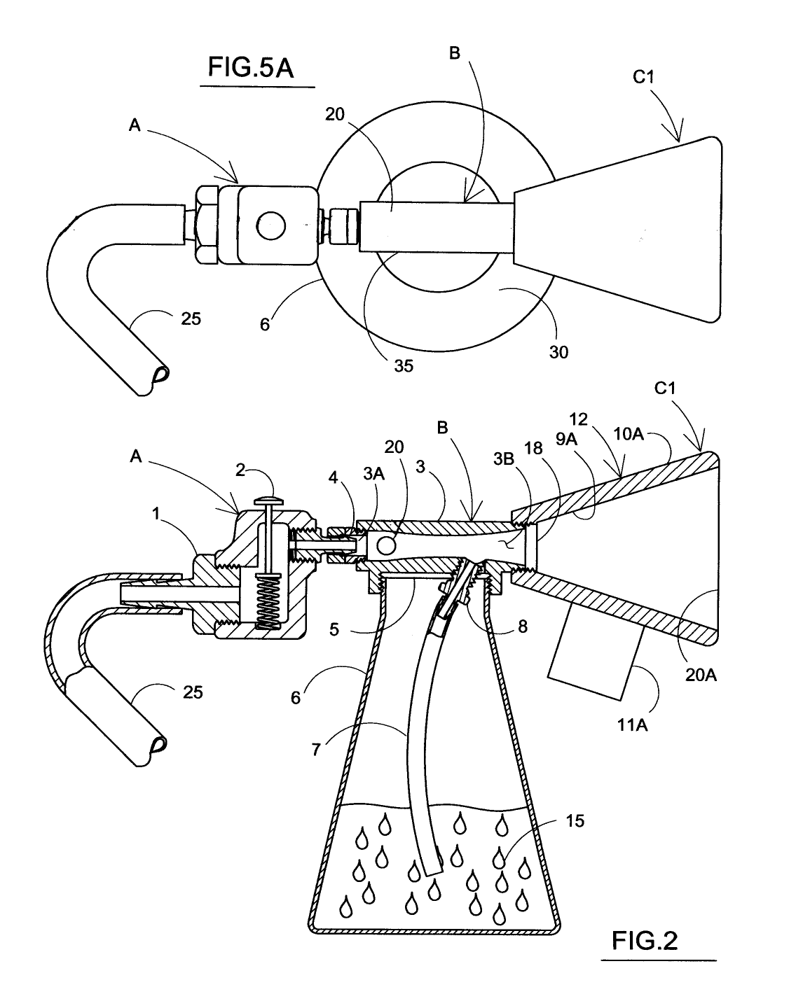

Module C may be rapidly attached and detached from the exit side 3B of the atomizing tube 3. Module C includes, but is not limited to, air containment structure (best seen in FIG. 2), nozzles 10, air shaping structures 11, and flexible wand-tubes 9 permitting spraying above, below, beside, underneath, and into a work piece. Again module C may be disposable, but generally, and especially, when employed with the same coating material, it may be employed at least once, and as many times as it is deemed appropriate by the user.

Referring now specifically to FIG. 2, a further example of modularization of the invention is shown. Module A still shows the atomizing gas connector and regulating mechanism. Atomizing gas enters module A via hose 25 (or other means) at atomizing gas input 1. Means to regulate the flow rate of the atomizing gas is shown at element 2. Element 4 shows an example of one of many possible quick connect-release mechanisms that may be provided. Element 4 interfits at element 3A which is the input end 3A of the atomizing tube 3 of Module B. One method of interfitting may be interrupted threads or partial threads. This is in no way limiting, as any connection method may be employed.

Module B once again is comprised of an atomizing gas tube 3 having a atomizing gas input at location 3A and an atomizing gas output at location 3B. Atomizing tube 3 is affixed centrally to the circularly shaped container cover 5. Any known means which would permit atomizing tube 3 to be affixed centrally to the circularly shaped container cover 5 is considered to be in the scope of the invention. This includes, but is not limited to, fasteners, adhesives, integral molding, melting the two pieces together, welding, mechanically interfitting or a chemical reaction resulting in attachment. A drain hose 7 passes through the container cover 5 underneath a point proximal to the atomization gas tube 3 output 3B. The drain hose 7 is secured in communication with both the coating material 15 and the atomization tube 3. The drain hose 7 may be secured to the atomization tube 3 in a variety or ways, but not specifically limited to, a barbed suction fitting 8.

Module C 1 in FIG. 2 includes a containment device outer wall 10A and a containment device inner wall 9A, The containment device 12 is a generally cylindrical device with a first end 18 of a first diameter, including rapid attach-detach means for connecting to output means 3A of module B. The containment means 12 includes a second side 20 of a second diameter. Element 11A is designed to be attached to a suction hose (not shown) which would pull the particles enclosed in the containment device 12 to a filter thus treating the air. This is essentially the patented Smith device shown in U.S. Pat. No. 7,550,022. Module C1 may be referred to as a CAPS device, (Capture Air Pollution System).

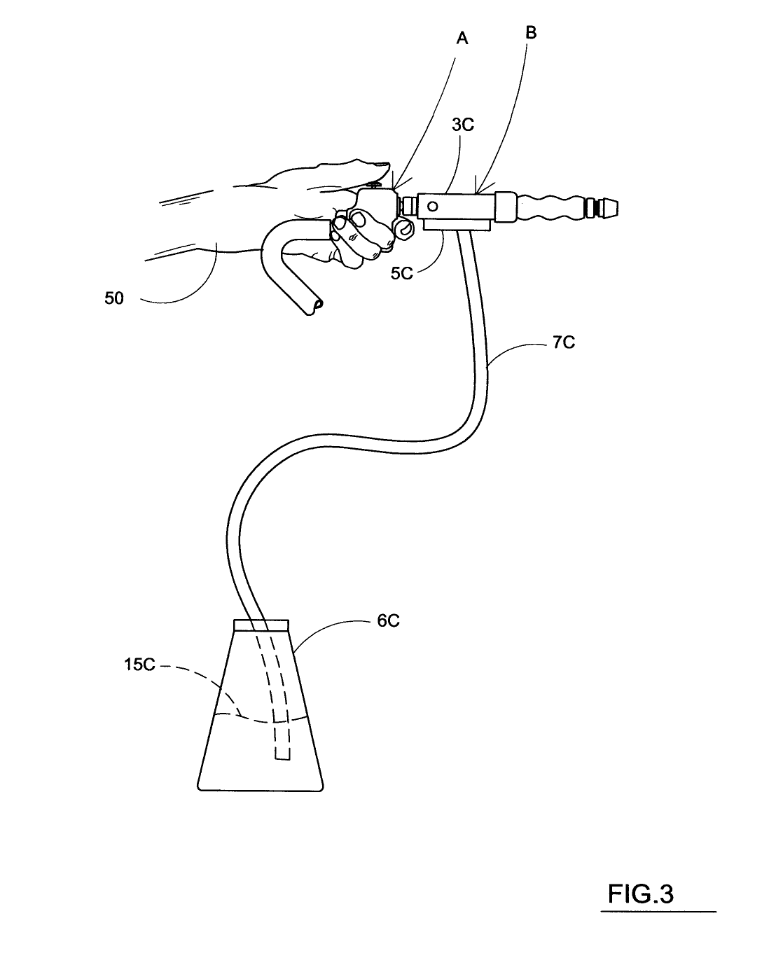

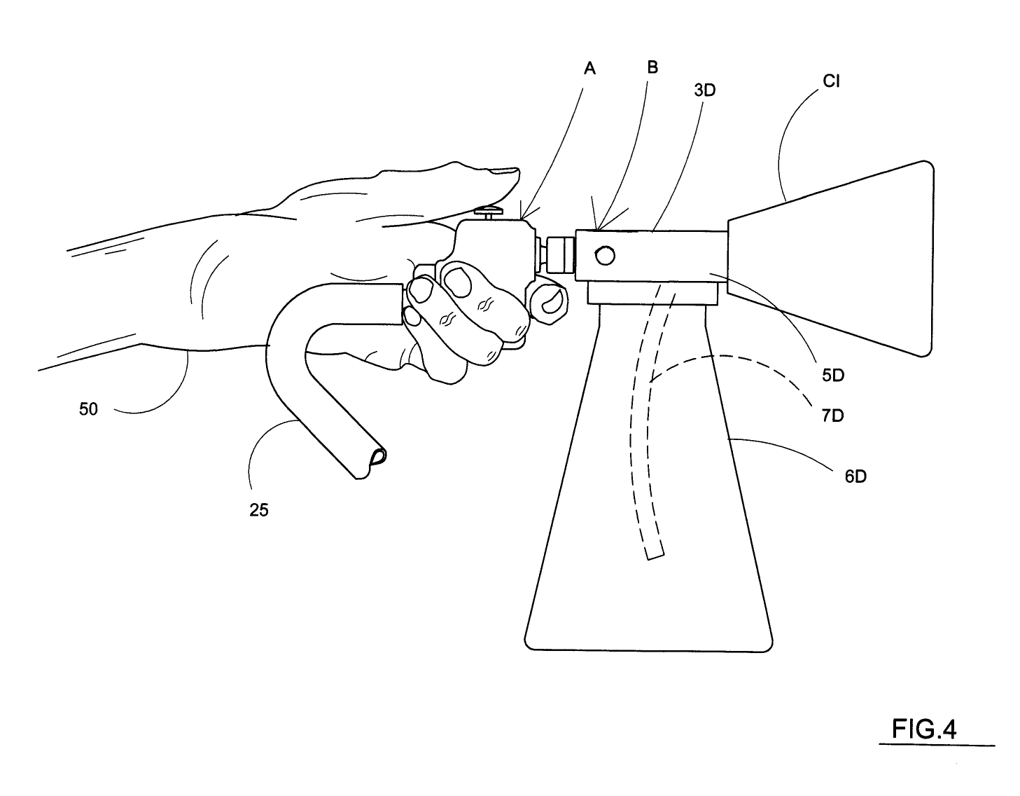

Referring now specifically to FIG. 3, worker 50 is shown. In the worker's hand is Module A, described in the above descriptions of FIGS. 1 and 2. Module A is connected to a atomizing gas source, that source being affixed to Module A by a hose (not shown). Module A is shown proximal to Module B, the same Module B as described in either the description of FIG. 1 or FIG. 2. Since no Module C is shown, the exact configuration of Module B is not known, for the sakes of this invention and this drawing Figure, consider this a generic Module B. If one were to look at FIG. 4, the optional Module C attachments are shown. Depending from Module B is a drain hose 7C which resides in the material 15C to be sprayed. The material 15C resides in the container 6C. The container attachment means 5C in this use of the invention is designed to be apart from the container 6C. The atomizing tube 3C creates enough energy to draw the material 15C up the drain hose 7c into the atomizing tube 3c where the material is atomized.

Referring now to FIG. 4, worker 50 is again shown. In his hand he holds Module B, just prior to being affixed to Module A. Module A is connected to an atomizing gas source, that source being affixed to Module A by a hose (not shown). In this configuration, the drain hose 7D is placed in container 6D. The container attachment means 5D will be affixed atop the container 6D. The atomizing tube 3D atomized the material (not shown) to be sprayed. Optional modular attachments C1 and C are shown. Both of these modules have been previously described in detail.

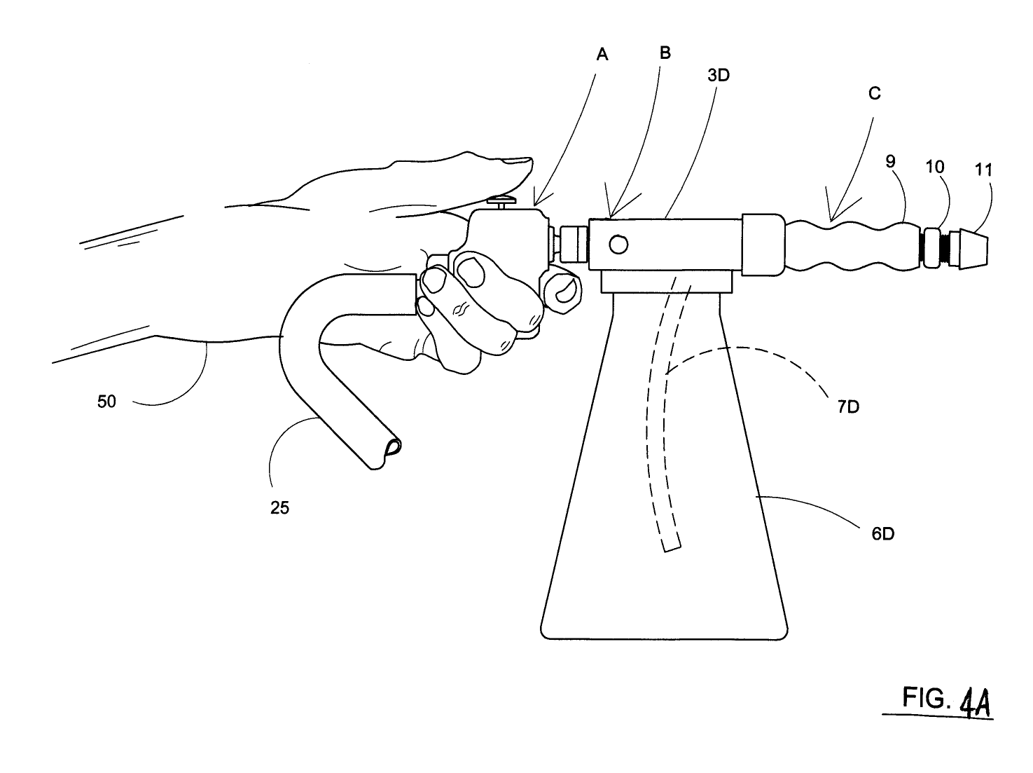

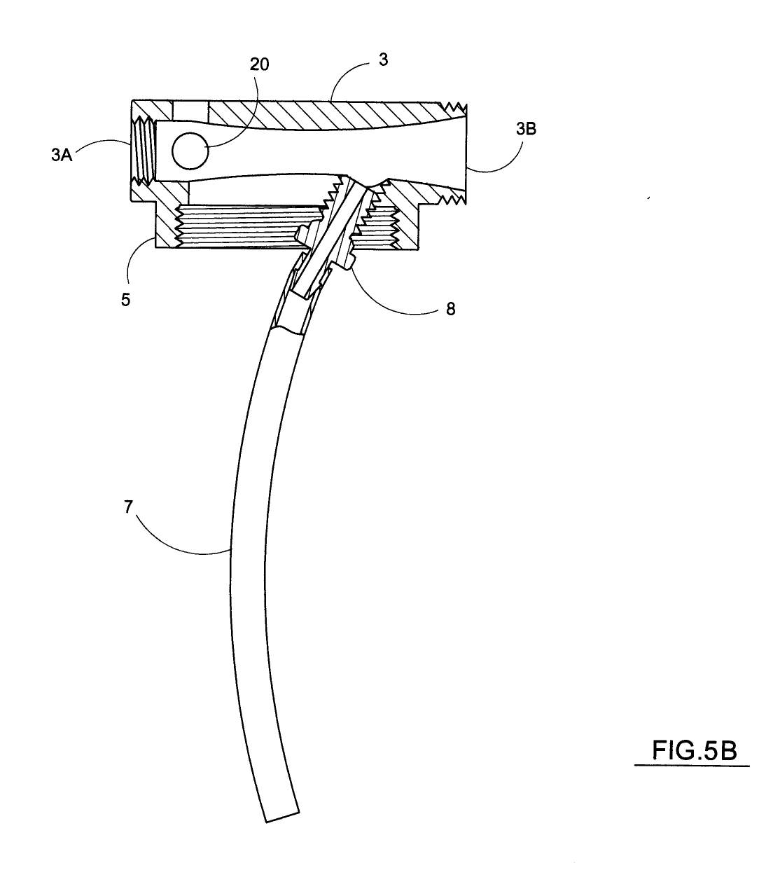

Referring now to FIG. 5A, a top view of Module B is shown. The atomizing tube 35 is affixed centrally atop the circular container attachment means 30. There may exist situations, perhaps in containers such as bladders, where the container attachment means may be a different geometric configuration other that circular. Any appropriate geometric shape may be chosen if required for a different geometry material container.

FIG. 5B discloses a side view of the atomizer module, with the suction hose interface shown in para exploded view. Such a view is described in the brief description of the drawings. Module B once again is comprised of an atomizing gas tube 3 having a atomizing gas input at location 3A and an atomizing gas output at location 3B. Atomizing tube 3 is affixed centrally to the circularly shaped container cover 5. Any known means which would permit atomizing tube 3 to be affixed centrally to the circularly shaped container cover 5 is considered to be in the scope of the invention. This includes, but is not limited to, fasteners, adhesives, integral molding, melting the two pieces together, welding, mechanically interfitting or a chemical reaction resulting in attachment. A drain hose 7 passes through the container cover 5 underneath a point proximal to the atomization gas tube 3 output 3B. The drain hose 7 is secured in communication with both the coating material 15 and the atomization tube 3. The drain hose 7 may be secured to the atomization tube 3 in a variety or ways, but not specifically limited to, a barbed suction fitting 8. Atomizing tube 3, in one embodiment of the invention, may include a plurality of air intake ports 20 located proximal the atomizing tube 3 input side 3A.

1. A modular part for a spraying system, said spraying system having at least an atomizing air source, said modular part comprising,
an atomizing tube,
a container attachment means, said container attachment means having a top side and a bottom side, a drain hose, said drain hose having a distal end and a proximal end, said drain hose proximal end having a securing means, whereby
said atomizing tube is permanently affixed to said container attachment means top side and said drain hose proximal end is secured to said atomizing tube by said securing means.

2. A modular part for a spraying system as claimed in claim 1 wherein said atomizing tube has an input side and an output side.

3. A modular part for a spraying system as claimed in claim 2 wherein said drain hose proximal end is secured near said atomizing tube output side.

4. A modular part for a spraying system as claimed in claim 3 wherein said atomizing tube input includes an atomizing tube input side attachment means designed for attachment with an atomizing air source.

5. (canceled)

6. (canceled)

7. (canceled)

8. (canceled)

9. (canceled)

10. (canceled)

11. (canceled)

12. (canceled)

13. (canceled)

14. (canceled)

15. A modular part for a spraying system as claimed in claim 4 wherein said modular part is designed specifically to be disposed of after use and then replaced by a new modular part.

16. (canceled)

17. A modular part for a spraying system as claimed in claim 4 wherein said atomizing tube output side is connected to a device, said device selected from the group consisting of a flexible hose, an air containment device, a nozzle, and an overspray mitigation device.
